(19) United States
(12) Patent Application Publication
(10) Pub. No.: US 2013/0157710 A1
(43) Pub. Date: Jun. 20, 2013

(54) Methods Providing Multipoint Communications Based on Sector Loads And Related Network Nodes

(71) Applicants: Sairamesh Nammi, Stockholm (SE); Paulson Angelo Vijay Silveris, Spanga (SE)

(72) Inventors: Sairamesh Nammi, Stockholm (SE); Paulson Angelo Vijay Silveris, Spanga (SE)

(73) Assignee: Telefonaktiebolaget LM Ericsson(pUb), Stockholm (SE)

(21) Appl. No.: 13/328,139

(22) Filed: Dec. 16, 2011

(51) Int. Cl. H04W 36/24

(52) U.S. Cl. 455/525

(57) ABSTRACT

A method providing communications for a wireless terminal in a wireless communication network may include providing communications for the wireless terminal from a first antenna array for a first base station sector. Responsive to receiving an entry notification that the wireless terminal has entered a border area between the first base station sector and a second base station sector, a load in the second base station sector may be compared with a load threshold. Responsive to the load in the second base station sector being less than the load threshold, multipoint communications may be provided for the wireless terminal through the first antenna array for the first base station sector and through a second antenna array for the second base station sector. Responsive to the load in the second base station sector being greater than the load threshold, multipoint communications may be blocked for the wireless terminal.

### TECHNICAL FIELD

The present disclosure is directed to wireless communications and, more particularly, to multipoint wireless communications and related network nodes.

### BACKGROUND

In a typical cellular radio system, wireless terminals (also referred to as user equipment unit nodes, UEs, and/or mobile stations) communicate via a radio access network (RAN) with one or more core networks. The RAN covers a geographical area which is divided into cell areas, with each cell area being served by a radio base station (also referred to as a RAN node, a “NodeB”, and/or enhanced NodeB “eNodeB”). A cell area is a geographical area where radio coverage is provided by the base station equipment at a base station site. The base stations communicate through radio communication channels with UEs within range of the base stations.

Moreover, a cell area for a base station may be divided input a plurality of sectors surrounding the base station. For example, a base station may service three 120 degree sectors surrounding the base station, and the base station may provide a respective directional transceiver and antenna array for each sector. Stated in other words, a base station may include three directional antenna arrays servicing respective 120 degree base station sectors surrounding the base station.

Multi-antenna techniques can significantly increase capacity, data rates, and/or reliability of a wireless communication system as discussed, for example, by Telatar in “Capacity Of Multi-Antenna Gaussian Channels” (European Transactions On Telecommunications, Vol. 10, pp. 585-595, November 1999). Performance may be improved if both the transmitter and the receiver for a base station sector are equipped with multiple antennas (e.g., an antenna array) to provide a multiple-input multiple-output (MIMO) communication channel(s) for the base station sector. Such systems and/or related techniques are commonly referred to as MIMO. The LTE standard is currently evolving with enhanced MIMO support and MIMO antenna deployments. A spatial multiplexing mode is provided for relatively high data rates in more favorable channel conditions, and a transmit diversity mode is provided for relatively high reliability (at lower data rates) in less favorable channel conditions.

In a downlink from a base station transmitting from a sector antenna array over a MIMO channel to a wireless terminal in the sector, for example, spatial multiplexing (or SM) may allow the simultaneous transmission of multiple symbol streams over the same frequency from different antennas of the base station antenna array for the sector. Stated in other words, multiple symbol streams may be transmitted from different antennas of the base station antenna array for the sector to the wireless terminal over the same downlink time/frequency resource element (TFRE) to provide an increased data rate. In a downlink from the same base station sector transmitting from the same antenna array to the same wireless terminal, transmit diversity (e.g., using space-time codes) may allow the simultaneous transmission of the same symbol stream over the same frequency from different antennas of the base station sector antenna array. Stated in other words, the same symbol stream may be transmitted from different antennas of the base station sector antenna array to the wireless terminal over the same time/frequency resource element (TFRE) to provide increased reliability of reception at the wireless terminal due to transmit diversity gain.

To further increase throughput at a sector/cell edge using High Speed Downlink Packet Access (HSDPA), MultiPoint-HSDPA (MP-HSDPA) has been proposed for 3^{rd} Generation Partnership Project (3GPP) communications. In MP-HSDPA, transport blocks of a data stream may be transmitted from two different sectors/cells of the same or different base stations to a same wireless terminal in a border area between the sectors/cells. Intra Node-B aggregation (also referred to as intra node multipoint communications) occurs when different transport blocks of a data stream are transmitted from two different sectors of a same base station to a wireless terminal, and Inter Node-B aggregation (also referred to as inter node multipoint communications) occurs when different transport blocks of a data stream are transmitted from sectors of different base stations to a wireless terminal. MP-HSDPA may thus provide advantages of parallel data streams like MIMO where the spatially separated antennas are taken from different sectors/cells.

Gains due to MP-HSDPA may diminish, however, as an offered load of a sector increases, and in fact, use of MP-HSDPA may cause a loss in sector throughput.

### SUMMARY

It is therefore an object to address at least some of the above mentioned disadvantages and/or to improve performance in a wireless communication system.

According to some embodiments, a method providing communications for a wireless terminal in a wireless communication network may include providing communications (e.g., single point communications) for the wireless terminal from a first antenna array for a first base station sector. Responsive to receiving an entry notification that the wireless terminal has entered a border area between the first base station sector and a second base station sector, a load in the second base station sector may be compared with a load threshold. Responsive to the load in the second base station sector being less than the load threshold, multipoint communications for the wireless terminal may be provided through the first antenna array for the first base station sector and through a second antenna array for the second base station sector. Responsive to the load in the second base station sector being greater than the load threshold, multipoint communications for the wireless terminal may be blocked while continuing to provide communications (e.g., single point communications) for the wireless terminal through the first antenna array of the first base station sector.

A decision to provide multipoint communications for a wireless terminal in a border area between two base station sectors may thus be made responsive to a load in secondary sector. Accordingly, multipoint communications for a wireless terminal may be blocked if such multipoint communications would be expected to reduce performance of the network.

Comparing the load may include comparing a first load with the load threshold at a first time, and a multipoint evaluation timer may be initiated responsive to blocking multipoint communications for the wireless terminal. Responsive to expiration of the multipoint evaluation timer, a second load (e.g., a current load) in the second base station sector may be compared with the load threshold at a second time (subsequent to the first time). Responsive to the second load in the second base station sector being greater than the load threshold, multipoint communications for the wireless terminal may be blocked while continuing to provide communications for the wireless terminal through the first antenna array for the first base station sector.

Responsive to receiving an exit notification that the wireless terminal has exited the border area between the first base station sector and the second base station sector after providing multipoint communications, multipoint communications for the wireless terminal may be terminated. After terminating multipoint communications, communications (e.g., single point communications) with the wireless terminal may be maintained through one of the first antenna array for the first base station sector or the second antenna array for the second base station sector.

The first antenna array for the first base station sector and the second antenna array for the second base station sector may be respective directional first and second antenna arrays co-located at a same base station with the directional first and second antenna arrays being directed to different directions from the base station. In other embodiments, the first antenna array for the first base station sector and the second antenna array for the second base station sector may be located at respective separate and spaced apart first and second base stations.

Providing multipoint communications may include transmitting a first transport block from the first antenna array for the first base station sector to the wireless terminal and transmitting a second transport block from the second antenna array for the second base station sector to the wireless terminal, with the first and second transport blocks being transmitted using a same frequency during a same time interval (e.g., using a same TFRE).

The load in the second base station sector may be determined based on usage by wireless terminals communicating through the second antenna array for the second base station sector. The load, for example, may be determined based on a number of active terminals communicating through the second antenna array for the second base station sector, based on an aggregate data rate transmitted over downlinks to active terminals communicating through the second antenna array for the second base station sector, and/or based on a quantity of data transmitted over downlinks to active terminals communicating through the second antenna array for the second base station sector. Moreover, the load in the second base station sector may be calculated based on the usage by the wireless terminals communicating through the second antenna array over a period of time that precedes receiving the notification that the wireless terminal has entered the border area.

According to some other embodiments, a node in a wireless communication network may provide communications for a wireless terminal, with the wireless communication network including first and second antenna arrays for respective first and second base station sectors. The node may include an interface configured to provide a coupling with the first and second antenna arrays, and a processor coupled to the interface. The processor may be configured to provide communications for the wireless terminal through the interface and the first antenna array for the first base station sector, and to compare a load in the second base station sector with a load threshold responsive to receiving an entry notification that the wireless terminal has entered a border area between the first base station sector and the second base station sector. The processor may be further configured to provide multipoint communications for the wireless terminal through the interface and the first and second antenna arrays responsive to the load in the second base station sector being less than the load threshold. Responsive to the load in the second base station sector being greater than the load threshold, the processor may be configured to block multipoint communications for the wireless terminal while continuing to provide communications for the wireless terminal through the interface and the first antenna array.

The processor may be configured to compare the load by comparing a first load with the load threshold at a first time, to initiate a multipoint timer responsive to blocking multipoint communications for the wireless terminal, and to compare a second load (e.g., a current load) in the second base station sector with the load threshold at a second time subsequent to the first time responsive to expiration of the multipoint evaluation timer. Responsive to the second load in the second base station sector being greater than the load threshold, the processor may be configured to block multipoint communications for the wireless terminal while continuing to provide communications for the wireless terminal through the interface and the first antenna array.

The processor may be further configured to terminate multipoint communications for the wireless terminal responsive to receiving an exit notification that the wireless terminal has exited the border area between the first base station sector and the second base station sector. Moreover, the processor is configured to maintain communications with the wireless terminal through the interface and one of the first antenna array or the second antenna array after terminating multipoint communications.

The first antenna array and the second antenna array may be respective directional first and second antenna arrays co-located at a same base station, with the directional first and second antenna arrays being directed to different directions around the base station. According to some other embodiments, the first antenna array and the second antenna array may be located at respective separate and spaced apart first and second base stations.

The processor may be configured to provide multipoint communications by transmitting a first transport block through the interface and the first antenna array to the wireless terminal and by transmitting a second transport block through the interface and the second antenna array to the wireless terminal, with the first and second transport blocks being transmitted using a same frequency during a same time interval.

The load in the second base station sector may be determined based on usage by wireless terminals communicating through the second antenna array for the second base station sector. For example, the load may be determined based on a number of active terminals communicating through the second base station sector, based on an aggregate data rate transmitted over downlinks to active terminals communicating through the second base station sector, and/or based on a quantity of data transmitted over downlinks to active terminals communicating through the second base station sector. Moreover, the load in the second base station sector may be calculated based on the usage by the wireless terminals communication through the second antenna array over a period of time that precedes receiving the notification that the wireless terminal has entered the border area.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of a communication system that is configured according to some embodiments;

FIGS. 2A, 2B, and 2C are block diagrams respectively illustrating a base station, a base station controller, and a radio network controller according to some embodiments of FIG. 1;

FIGS. 3A and 3B are schematic diagrams respectively illustrating intra node and inter node multipoint communications according to some embodiments;

FIG. 4 is a flow chart illustrating operations providing multipoint communications according to some embodiments; and

FIGS. 5, 6, and 7 are graphs illustrating network performance according to some embodiments.

### DETAILED DESCRIPTION

The invention will now be described more fully hereinafter with reference to the accompanying drawings, in which examples of embodiments of the invention are shown. This invention may, however, be embodied in many different forms and should not be construed as limited to the embodiments set forth herein. Rather, these embodiments are provided so that this disclosure will be thorough and complete, and will fully convey the scope of the present invention to those skilled in the art. It should also be noted that these embodiments are not mutually exclusive. Components from one embodiment may be tacitly assumed to be present/used in another embodiment.

For purposes of illustration and explanation only, these and other embodiments of the present invention are described herein in the context of operating in a RAN that communicates over radio communication channels with wireless terminals (also referred to as UEs). It will be understood, however, that the present invention is not limited to such embodiments and may be embodied generally in any type of communication network. As used herein, a wireless terminal (also referred to as a UE) can include any device that receives data from a communication network, and may include, but is not limited to, a mobile telephone (“cellular” telephone), laptop/portable computer, pocket computer, hand-held computer, and/or desktop computer.

In some embodiments of a RAN, several base stations can be connected (e.g., by landlines or radio channels) to a radio network controller (RNC). The radio network controller, also sometimes termed a base station controller (BSC), supervises and coordinates various activities of the plural base stations connected thereto. The radio network controller is typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) technology. UTRAN, short for UMTS Terrestrial Radio Access Network, is a collective term for the Node B's and Radio Network Controllers which make up the UMTS radio access network. Thus, UTRAN is essentially a radio access network using wideband code division multiple access for UEs.

The Third Generation Partnership Project (3GPP) has undertaken to further evolve the UTRAN and GSM based radio access network technologies. In this regard, specifications for the Evolved Universal Terrestrial Radio Access Network (E-UTRAN) are ongoing within 3GPP. The Evolved Universal Terrestrial Radio Access Network (E-UTRAN) comprises the Long Term Evolution (LTE) and System Architecture Evolution (SAE).

Note that although terminology from 3GPP (3^{rd} Generation Partnership Project) LTE (Long Term Evolution) is used in this disclosure to exemplify embodiments of the invention, this should not be seen as limiting the scope of the invention to only these systems. Other wireless systems, including WCDMA (Wideband Code Division Multiple Access), WiMax (Worldwide Interoperability for Microwave Access), UMB (Ultra Mobile Broadband), HSDPA (High-Speed Downlink Packet Access), GSM (Global System for Mobile Communications), etc., may also benefit from exploiting embodiments of the present invention disclosed herein.

Also note that terminology such as base station (also referred to as eNodeB or Evolved Node B) and wireless terminal (also referred to as UE or User Equipment) should be considering non-limiting and does not imply a certain hierarchical relation between the two. In general a base station (e.g., an “eNodeB”) and a wireless terminal (e.g., a “UE”) may be considered as examples of respective different communications devices that communicate with each other over a wireless radio channel. While embodiments discussed herein may focus on wireless transmissions in a downlink from an eNodeB to a UE, embodiments of the invention may also be applied, for example, in the uplink.

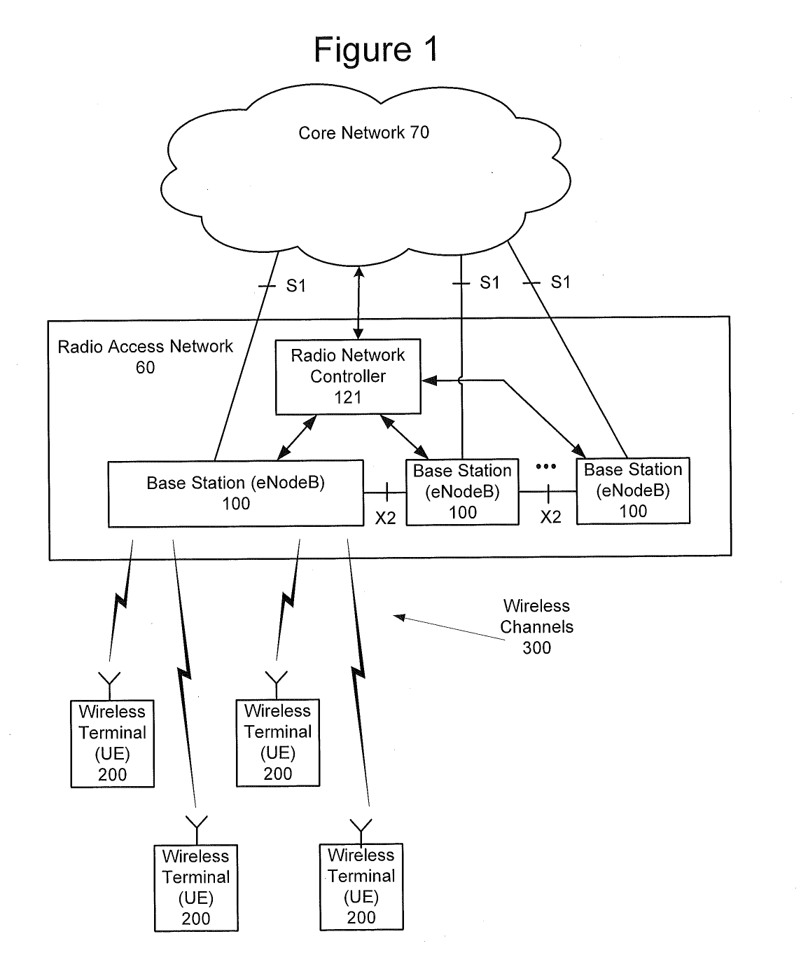

FIG. 1 is a block diagram of a communication system that is configured to operate according to some embodiments of the present invention. An example RAN 60 is shown that may be a Long Term Evolution (LTE) RAN. Radio base stations (e.g., eNodeBs) 100 may be connected directly to one or more core networks 70, and/or radio base stations 100 may be coupled to core networks 70 through one or more radio network controllers (RNC) 121. In some embodiments, functions of radio network controller (RNC) 100 may be performed by radio base stations 100. Radio base stations 100 communicate over wireless channels 300 with wireless terminals (also referred to as user equipment nodes or UEs) 200 that are within their respective communication service cells (also referred to as coverage areas). The radio base stations 100 can communicate with one another through an X2 interface and with the core network(s) 70 through Si interfaces, as is well known to one who is skilled in the art.

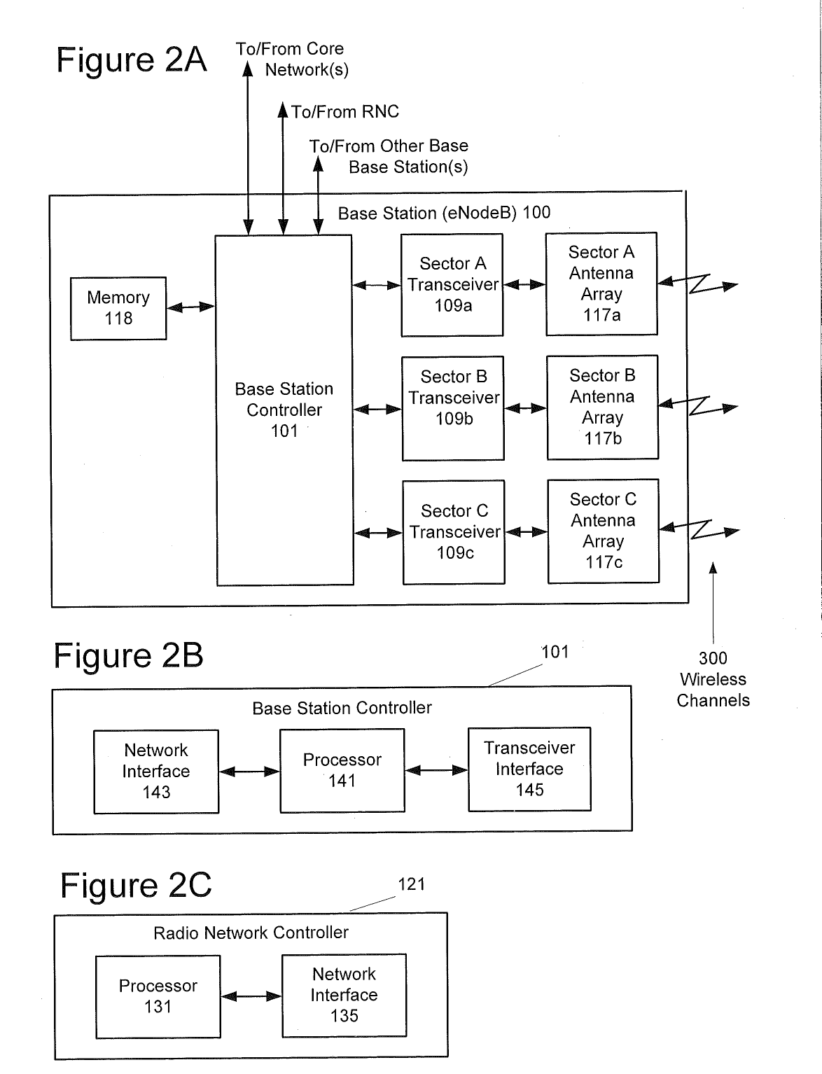

FIG. 2A is a block diagram of a base station 100 of FIG. 1 configured to provide service over three 120 degree sectors (sectors A, B, and C) surrounding the base station according to some embodiments. As shown, for example, base station 100 may include three transceivers 109a, 109b, and 109c coupled between base station controller 101 and respective antenna arrays 117a, 117b, and 117c (each of which may include multiple MIMO antennas), and memory 118 coupled to processor 101.

More particularly, each transceiver 109 may include a receiver and a transmitter. Each receiver may be configured to generate digital data streams corresponding to one or more transport blocks received through the respective antenna array 117 from wireless terminals 200 located in a sector serviced by the respective antenna array. Each transmitter may be configured to transmit one or more transport blocks through the respective antenna array 117 to wireless terminals 200 located in the sector serviced by the antenna array responsive to a digital data stream from processor 101. Accordingly, base station 100 of FIG. 1 may define three 120 degree sectors A, B, and C surrounding the base station, transceiver 109a and antenna array 117a may support MIMO communications for wireless terminals 200 in sector A of base station 100, transceiver 109b and antenna array 117b may support MIMO communications for wireless terminals 200 in sector B of base station 100, and transceiver 109c and antenna array 117c may support MIMO communications for wireless terminals 200 in sector C of base station 100.

FIG. 2B is a block diagram of base station controller 101 of FIG. 2A according to some embodiments. As shown, for example, base station controller 101 may include processor 141, network interface 143, and transceiver interface 145. Network interface 143 may provide a communications interface between processor 141 and core network 70, between processor 141 and RNC 121, and/or between processor 141 and other base stations 100. Transceiver interface 145 may be configured to provide a communications interface between processor 141 and each of transceivers 109a, 109b, and 109c.

FIG. 2C is a block diagram of radio network controller (RNC) 121 of FIG. 1 according to some embodiments. As shown, for example, RCN 121 may include processor 131 and network interface 135. Network interface 143 may provide a communications interface between processor 131 and base stations 100 and/or between processor 131 and core network 70.

In a downlink direction, RNC 121 (or processor 131 thereof) may split out different downlink data streams from core network 70 to respective base stations 100 for transmission to wireless terminals 200 in communication with the respective base stations 100. For downlink data streams received at a particular base station 100, the base station controller 101 (or processor 141 thereof) may split out different ones of the downlink data streams for transmission through the transceivers and antenna arrays of the respective sectors A, B, and C to wireless terminals 200 communicating through the respective sectors of the base station.

In an uplink direction, base station controller 101 (or processor 141 thereof) may combine the different uplink data streams received through the antenna arrays and sectors of sectors A, B, and C. Similarly, RNC 121 (or processor 135 thereof) may combine the uplink data streams from the different base stations 100, and transmit the combined uplink data streams to core network 70.

A downlink data stream for a particular wireless terminal 200 may thus include a plurality of transport blocks provided from core network 70 through radio network controller 121, through base station controller 101 of the base station 100 with which the wireless terminal 200 is communicating, and through the transceiver 109 and antenna array 117 for the sector in which the wireless terminal 200 is located. For every transport block received at RNC 121, processor 131 of RNC 121 may direct the downlink transport block to a respective base station 100, and for every transport block 117 received at a base station 100, processor 141 of base station controller 101 may direct the downlink transport block to a respective transceiver and antenna array for transmission over the appropriate sector.

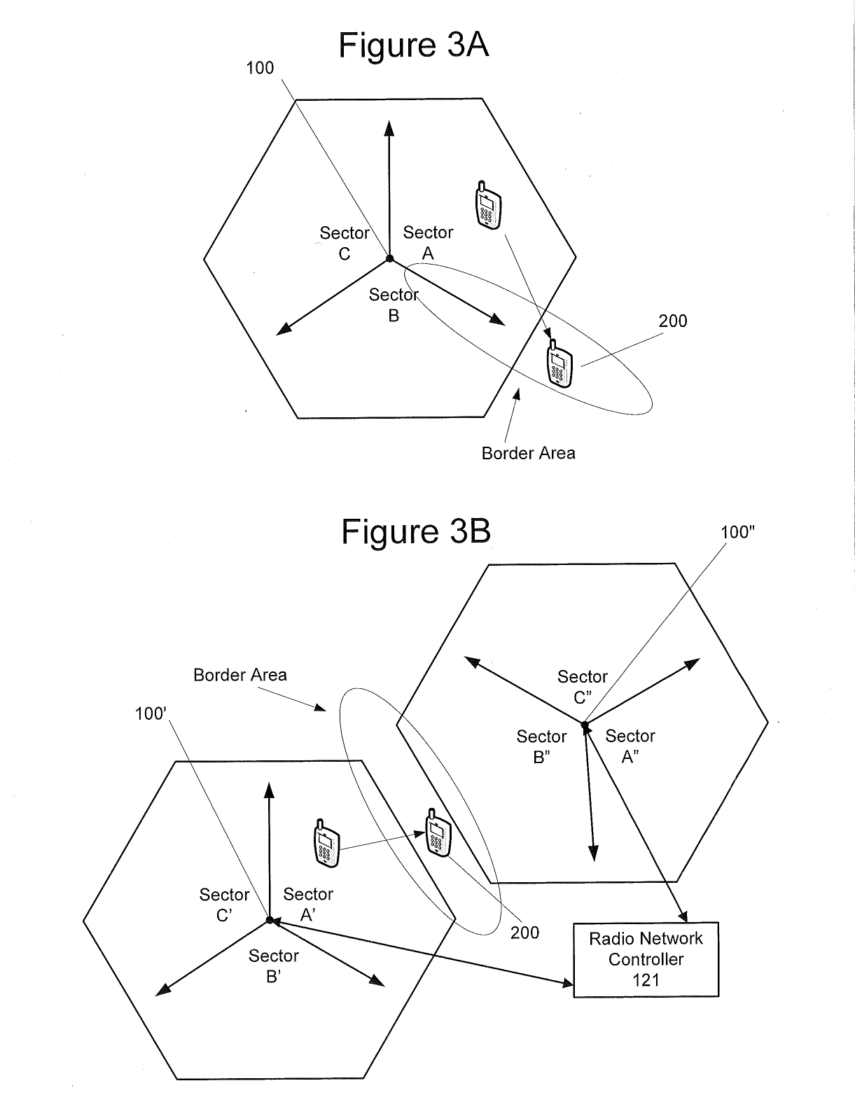

When a wireless terminal is located in a border area between two sectors, transport blocks from the same downlink stream (e.g., supporting a radiotelephone voice communication between the wireless terminal and another communication device, supporting a data communication between the wireless terminal and a remote server, etc.) may be transmitted from antenna arrays of the two different sectors to the wireless terminal to provide increase throughput using multipoint communications (e.g., using MP-HSDPA). If the two different sectors are co-located at a same base station, processor 141 of base station controller 101 may split the transport blocks of the downlink data stream to the different transceivers 109 supporting the different sectors to provide intra node aggregation as discussed in greater detail below with respect to FIG. 3A. If the two different sectors are located at different base stations, processor 131 of RNC 121 may split the transport blocks of the downlink data stream to the different base stations 100 supporting the different sectors to provide inter node aggregation as discussed in greater detail below with respect to FIG. 3A.

As shown in FIG. 3A, base station 100 of FIG. 2A may support communications with wireless terminals in three different 120 degree sectors A, B, and C. More particularly, transceiver 109a and antenna array 117a may support MIMO communications with wireless terminals located in Sector A, transceiver 109b and antenna array 117b may support MIMO communications with wireless terminals located in Sector B, and transceiver 109c and antenna array 117c may support MIMO communications with wireless terminals located in Sector C. Stated in other words, each of antenna arrays 117a, 117b, and 117c (together with respective transceivers 109a, 109b, and 109c) defines a respective 120 degree sector A, B, and C. When wireless terminal 200 is initially located in a central portion of sector A as shown in FIG. 3A, RAN 60 may provide wireless communications for a downlink data stream (made up of transport blocks) by transmitting transport blocks of the downlink data stream through transceiver 109a and antenna array 117a over a wireless channel 300 to wireless terminal 200.

When wireless terminal 200 moves from a central portion of sector A to a border area between sectors A and B as indicated by the arrow in FIG. 3A, intra node multipoint communications may be used to transmit different transport blocks of the downlink data stream in parallel through transceiver 109a and antenna array 117a and through transceiver 109b and antenna array 117b to wireless terminal 200 (e.g., using MP-HSDPA). More particularly, different first and second transport blocks of the same data stream may be respectively transmitted from antenna arrays 117a and 117b using a same time/frequency resource element (TFRE) to increase downlink throughput for the wireless terminal in the border area (also referred to as a soft handover region). According to other embodiments, multipoint communications may be used to transmit the same transport block from antenna arrays 117a and 117b using a same TFRE to provide increased reliability of reception due to diversity gain.

When wireless terminal 200 is in a border area between two sectors A and B of the same base station 100 as shown in FIG. 3A, all transport blocks for the data stream to the wireless terminal 200 may be processed through a single base station controller 101 where the decision is made for each transport block of the data stream whether to transmit through antenna array 117a or 117b. Stated in other words, only one Radio Link Control (RLC) flow is required for the data stream with the data split being performed at a Media Access Control (MAC) layer using processor 141 of base station controller 101. With intra node multipoint communications as shown in FIG. 3A, the data split may be transparent with respect to RNC 121.

When wireless terminal 200 moves from a central portion of sector A to a border area between sectors A and B, processor 141 of base station controller 101 may decide whether to provide multipoint communications based on a load of sector B. If a load of sector B is less than a multipoint load threshold, processor 141 may begin multipoint communications for transport blocks of the data stream being transmitted to wireless terminal 200 in the border area. If a load of sector B is greater than the multipoint load threshold, processor 141 may block multipoint communications for wireless terminal 200 in the border area while continuing to provide single point communications for wireless terminal 200 through antenna array 117a of sector A. The load of sector B may be determined based on usage by wireless terminals communicating through antenna array 117b for sector B. For example, the load of sector B may be determined based on a number of active terminals communicating through antenna array 117b for base station sector B, based on an aggregate data rate transmitted over downlinks to active wireless terminals communicating through antenna array 117b for base station sector B, and/or based on a quantity of data transmitted over downlinks to active wireless terminals communicating through antenna array 117b for base station sector B. Moreover, the load of sector B may be calculated based on the usage by wireless terminals communicating through antenna array 117b over a period of time that precedes receiving the notification that the wireless terminal 200 has entered the border area between sectors A and B.

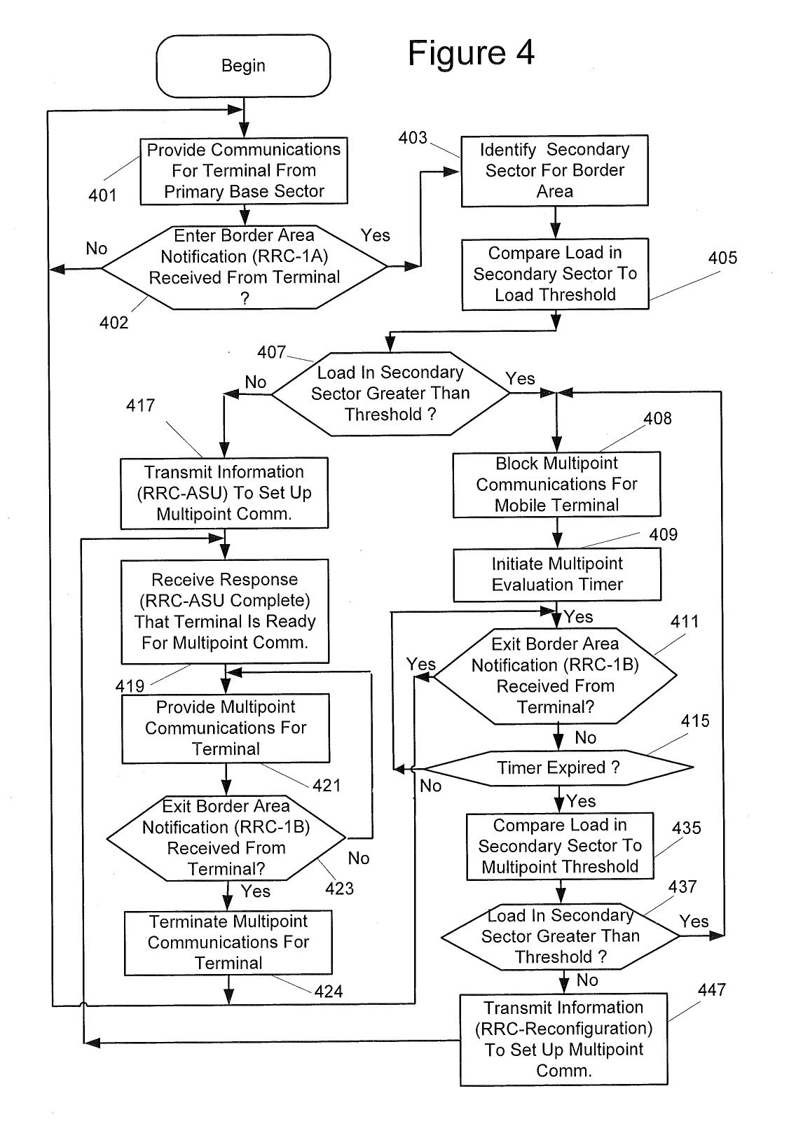

Operations to provide multipoint communications to wireless terminal 200 in the border area between sectors A and B of FIG. 3A are discussed in greater detail with respect to the flow chart of FIG. 4. Wireless terminal 200 may initially be located in a central portion of sector A (also referred to as a primary sector), and processor 141 of base station controller 101 may transmit transport blocks of a data stream through transceiver interface 145, transceiver 109a, and antenna array 117a (also referred to as a primary antenna array) for sector A to wireless terminal 200 (without providing multipoint communications) at block 401. Such single point communications may be provided for wireless terminal 200 as long as wireless terminal 200 remains in central portions of sector A.

If wireless terminal 200 moves from a central portion of sector A to a border area between sectors A and B as indicated by the arrow of FIG. 3A, wireless terminal 200 may transmit a notification of entry into the border area (e.g., a Radio Resource Control Event 1A message or an RRC-1A message). Wireless terminal 200, for example, may monitor control signals transmitted from antenna arrays 117a-c of base station 100 and/or from antenna arrays of other base stations, and measures of relative signal strengths of these control signals may be used by wireless terminal 200 to determine sectors and/or antenna arrays suitable for communication. If such a notification (e.g., an RRC-1A message) is received from wireless terminal 200 at base station 100 at block 402, processor 141 of base station controller 101 may identify sector B as a secondary sector for communication with wireless terminal 200 at block 403. The notification (e.g., the RRC-1A message) from wireless terminal 200, for example, may identify the primary and secondary sectors and/or antenna arrays that may be available for multipoint communications in the border area.

At block 405, processor 141 may compare a load in sector B (the secondary sector) with a multipoint load threshold. Responsive to the load in sector B being less than the multipoint load threshold at block 407, processor 141 may transmit information (e.g., a Radio Resource Control Active Set Update message or RRC-ASU message) at block 417 to set up multipoint communications with wireless terminal 200 in the border area between sectors A and sector B. Processor 141 may transmit the information (e.g., RRC-ASU message) through transceiver interface 145, transceiver 109a, and antenna array 117a to wireless terminal 200. Upon receipt of the information (e.g., RRC-ASU message), wireless terminal 200 may respond with a communication (e.g., a Radio Resource Control Active Set Update Complete message or RRC-ASU complete message) to confirm that the wireless terminal 200 is ready to receive multipoint communications.

Responsive to receipt of the communication (e.g., RRC-ASU complete message) from wireless terminal 200 at processor 141 at block 419 (through antenna array 117a, transceiver 109a, and transceiver interface 145), processor 141 may provide multipoint communications for wireless terminal 200 at block 421. More particularly, processor 141 may transmit some transport blocks of the data stream through transceiver interface 145, transceiver 109a and antenna array 117a to wireless terminal 200 while transmitting other transport blocks of the data stream through transceiver interface 145, transceiver 109b, and antenna array 117b to wireless terminal 200. Moreover, first and second different transport blocks of the same data stream may be respectively transmitted from antenna array 117a and from antenna array 117b to wireless terminal 200 using a same frequency during a same time interval (e.g., using a same TFRE).

As long as wireless terminal 200 remains in the border area between sectors A and B, processor 141 may continue providing multipoint communications for wireless terminal 200 at block 421. As noted above, wireless terminal 200 may monitor control signals and/or signal strengths thereof to determine base station antenna arrays and/or sectors suitable for communication. If wireless terminal 200 leaves the border area between sectors A and B, wireless terminal 200 may transmit a notification of exit from the border area (e.g., a Radio Resource Control 1B message or RRC-1B message). Upon receipt of such an exit notification at block 423, processor 141 may terminate multipoint communications for wireless terminal at block 424, and revert to providing single point communications from only a primary antenna array at block 401 (e.g., antenna array 117a if wireless terminal 200 moves into a central area of sector A or antenna array 117b if wireless terminal 200 moves into a central area of sector B). The exit notification (e.g., an RRC-1B message) may identify the sector and/or antenna array from which single point communications may be provided.

Looking again at blocks 405 and 407, if the load in sector B is greater than the multipoint load threshold at block 407, processor 141 may block multipoint communications for mobile terminal 200 at block 408 (even though wireless terminal 200 is located in the border area between sectors A and B), while continuing to provide single point communications for wireless terminal 200 by continuing to transmit all transport blocks of the data stream through transceiver interface 145, transceiver 109a, and antenna array 117a.

At block 409, processor 141 may initiate a multipoint timer responsive to blocking multipoint communications, and at block 415, processor 141 may monitor for expiration of the multipoint timer. At any time an exit notification (e.g., an RCC-1B message) is received from wireless terminal 200 (indicating exit of wireless terminal 200 from the border area between sectors A and B) at block 411, processor 141 may revert to operations of blocks 401 and 402. Exit notifications are discussed in greater detail above with respect to block 423, and the exit notification may identify a sector and/or antenna array from which single point communications should be received at wireless terminal 200.

Responsive to expiration of the multipoint timer at block 415, processor 141 may compare a current load in sector B (the secondary sector) with the multipoint load threshold. Responsive to the load in sector B being less than the multipoint load threshold at block 437, processor 141 may transmit information (e.g., a Radio Resource Control Reconfiguration message or RRC-Reconfiguration message) at block 447 to set up multipoint communications with wireless terminal 200 in the border area between sectors A and sector B. Processor 141 may transmit the information (e.g., an RRC-Reconfiguration message) through transceiver interface 145, transceiver 109a, and antenna array 117a to wireless terminal 200. Upon receipt of the information (e.g., RRC-ASU message), wireless terminal 200 may respond with a communication (e.g., a Radio Resource Control Active Set Update Complete message or RRC-ASU complete message) to confirm that the wireless terminal 200 is ready to receive multipoint communications. Responsive to receiving the RRC-ASU complete message from wireless terminal 200 at block 419, processor 141 may provide multipoint communications for wireless terminal 200 at block 421, and operations of blocks 421, 423, and 424 may be performed as discussed above.

Looking again at blocks 435 and 437, if the current load in sector B is greater than the multipoint load threshold at block 437, processor 141 may continue blocking multipoint communications for mobile terminal 200 at block 408 (even though wireless terminal 200 is located in the border area between sectors A and B), while continuing to provide single point communications for wireless terminal 200 by transmitting all transport blocks of the data stream through transceiver interface 145, transceiver 109a, and antenna array 117a. Moreover, processor 141 may re-initiate the multipoint evaluation timer at block 409 and wait for expiration of the multipoint evaluation timer at block 415 before rechecking a current load of sector B to determine whether multipoint communications may be provided for wireless terminal 200.

Operations of blocks 408, 409, 411, 415, 435, and 437 may thus be repeated while maintaining single point communications with wireless terminal 200 using antenna array 117a until either wireless terminal 200 exits the border area (as indicated by an RRC-1B message at block 411) or the load in sector B is less than the multipoint load threshold at block 437. As long as wireless terminal 200 remains in the border area between sectors A and B, processor 141 may periodically check the load of sector B to determine whether multipoint communications are appropriate for wireless terminal 200. Moreover, the period of such checks may be determined by a duration of the multipoint evaluation timer.

As shown in FIG. 3B, two base stations, identified as base stations 100′ and 100″, may support communications with wireless terminals, with each of base stations 100′ and 100″ separately having the structure of FIG. 2A (using prime and double prime notation to separately identify elements of the different base stations 100′ and 100″). In addition, each base station 100′ and 100″ may be coupled to RNC 121. Moreover, base stations 100′ may support MIMO communications with wireless terminals located in 120 degree sectors A′, B′, and C′ surrounding base station 100′, and base station 100″ may support MIMO communications with wireless terminals located in 120 degree sectors A″, B″, and C″ surrounding base station 100″. More particularly, transceiver 109a′ and antenna array 117a′ may support MIMO communications with wireless terminals located in Sector A′, transceiver 109b′ and antenna array 117b′ may support MIMO communications with wireless terminals located in Sector B′, and transceiver 109c′ and antenna array 117c′ may support MIMO communications with wireless terminals located in Sector C′. Similarly, transceiver 109a″ and antenna array 117a′ may support MIMO communications with wireless terminals located in Sector A″, transceiver 109b″ and antenna array 117b″ may support MIMO communications with wireless terminals located in Sector B″, and transceiver 109c″ and antenna array 117c″ may support MIMO communications with wireless terminals located in Sector C″. When wireless terminal 200 is initially located in a central portion of sector A′ as shown in FIG. 3A, RAN 60 may provide wireless communications for a downlink data stream made up of transport blocks by transmitting the downlink data stream through transceiver 109a′ and antenna array 117a′ over a wireless channel 300 to wireless terminal 200.

When wireless terminal 200 moves from a central portion of sector A′ to a border area between sectors A′ and B″ (of different base stations 100′ and 100″) as indicated by the arrow in FIG. 3B, inter node multipoint communications may be used to transmit different transport blocks of the downlink data stream in parallel through transceiver 109a′ and antenna array 117a′ of base station 100′ and through transceiver 109b″ and antenna array 117b″ of base station 100″ to wireless terminal 200 (e.g., using MP-HSDPA). More particularly, different first and second transport blocks of the same data stream may be respectively transmitted from antenna arrays 117a′ and 117b″ using a same time/frequency resource element (TFRE) to increase downlink throughput for the wireless terminal in the border area (also referred to as a soft handover region). According to other embodiments, multipoint communications may be used to transmit the same transport block from antenna arrays 117a′ and 117b″ using a same TFRE to provide increased reliability of reception due to diversity gain.

When wireless terminal 200 is in a border area between two sectors A′ and B″ of different base stations 100′ and 100″ as shown in FIG. 3B, all transport blocks for the data stream to the wireless terminal 200 may be processed through a single radio network controller (RNC) 121 where the decision is made for each transport block of the data stream whether to transmit through antenna array 117a′ of base station 100′ or antenna array 117b″ of base station 100″. Even though transport blocks of the data stream may be transmitted from antenna arrays 117a′ and 117b″ using a same TFRE, timing mismatch may occur because schedulers of base stations 100′ and 100″ may act independently and/or because transmission delays between wireless terminal 200 and base stations 100′ and 100″ may be different (due to different distances between wireless terminal 200 and base stations 100′ and 100″).

When wireless terminal 200 moves from a central portion of sector A′ to a border area between sectors A′ and B″, processor 131 of base station controller 101 may decide whether to provide multipoint communications based on a load of sector B″. If a load of sector B″ is less than a multipoint load threshold, processor 131 (of RNC 121) may begin multipoint communications for transport blocks of the data stream being transmitted to wireless terminal 200 in the border area. If a load of sector B″ is greater than the multipoint load threshold, processor 131 may block multipoint communications for wireless terminal 200 in the border area while continuing to provide single point communications for wireless terminal 200 through antenna array 117a′ of sector A′. The load of sector B″ may be determined based on usage by wireless terminals communicating through antenna array 117b″ for sector B″. For example, the load of sector B″ may be determined based on a number of active terminals communicating through antenna array 117b″ for base station sector B″, based on an aggregate data rate transmitted over downlinks to active wireless terminals communicating through antenna array 117b″ for base station sector B″, and/or based on a quantity of data transmitted over downlinks to active wireless terminals communicating through antenna array 117b″ for base station sector B″. Moreover, the load of sector B″ may be calculated based on the usage by wireless terminals communicating through antenna array 117b″ over a period of time that precedes receiving the notification that the wireless terminal 200 has entered the border area between sectors A′ and B″.

Operations to provide multipoint communications to wireless terminal 200 in the border area between sectors A′ and B″ of FIG. 3B are discussed in greater detail with respect to the flow chart of FIG. 4. Wireless terminal 200 may initially be located in a central portion of sector A′ (also referred to as a primary sector) of base station 100′, and processor 131 of RNC 121 may transmit transport blocks of a data stream through network interface 135, base station controller 101′, transceiver 109a′, and antenna array 117a′ (also referred to as a primary antenna array) for sector A′ to wireless terminal 200 (without providing multipoint communications) at block 401. Such single point communications may be provided for wireless terminal 200 as long as wireless terminal 200 remains in central portions of sector A′.

If wireless terminal 200 moves from a central portion of sector A′ to a border area between sectors A′ and B″ as indicated by the arrow of FIG. 3B, wireless terminal 200 may transmit a notification of entry into the border area (e.g., a Radio Resource Control Event 1A message or an RRC-1A message). Wireless terminal 200, for example, may monitor control signals transmitted from antenna arrays 117a′-c′ and 117a″-c″ of base stations 100′ and 100″ and/or from antenna arrays of other base stations, and measures of relative signal strengths of these control signals may be used by wireless terminal 200 to determine base stations, sectors and/or antenna arrays suitable for communication. If such a notification (e.g., an RRC-1A message) is received from wireless terminal 200 at base station 100′ and/or base station 100″ at block 402, processor 131 of RNC 121 may identify sector B″ of base station 100″ as a secondary sector for communication with wireless terminal 200 at block 403. The notification (e.g., the RRC-1A message) from wireless terminal 200, for example, may identify the primary and secondary base stations, sectors, and/or antenna arrays that may be available for multipoint communications in the border area.

At block 405, processor 131 may compare a load in sector B″ (the secondary sector) of base station 100″ with a multipoint load threshold. Responsive to the load in sector B″ being less than the multipoint load threshold at block 407, processor 131 may transmit information (e.g., a Radio Resource Control Active Set Update message or RRC-ASU message) at block 417 to set up multipoint communications with wireless terminal 200 in the border area between sector A′ and sector B″. Processor 131 may transmit the information (e.g., RRC-ASU message) through network interface 145, base station controller 101′, transceiver 109a′, and antenna array 117a′ to wireless terminal 200. Upon receipt of the information (e.g., RRC-ASU message), wireless terminal 200 may respond with a communication (e.g., a Radio Resource Control Active Set Update Complete message or RRC-ASU complete message) to confirm that the wireless terminal 200 is ready to receive multipoint communications.

Responsive to receipt of the communication (e.g., RRC-ASU complete message) from wireless terminal 200 at processor 131 at block 419 (through antenna array 117a′, transceiver 109a′, base station controller 101′, and network interface 135), processor 131 may provide multipoint communications for wireless terminal 200 at block 421. More particularly, processor 131 may transmit some transport blocks of the data stream through network interface 135, base station controller 101′, transceiver 109a′, and antenna array 117a′ to wireless terminal 200 while transmitting other transport blocks of the data stream through network interface 135, base station controller 101″, transceiver 109b″, and antenna array 117b″ to wireless terminal 200. Moreover, first and second different transport blocks of the same data stream may be respectively transmitted from antenna array 117a′ and from antenna array 117b″ to wireless terminal 200 using a same frequency during a same time interval (e.g., using a same TFRE). As noted above, a mismatch of reception times for inter node multipoint communications at wireless terminal 200 may be greater than a mismatch of reception times for intra node multipoint communications because base stations 100′ and 100″ may use independent schedulers and/or because a distance between mobile terminal 200 and base station 100′ may be different than a distance between mobile terminal 200 and base station 100″ (resulting in different transmission delays).

As long as wireless terminal 200 remains in the border area between sector A′ of base station 100′ and sector B″ of base station 100″, processor 131 may continue providing multipoint communications for wireless terminal 200 at block 421. As noted above, wireless terminal 200 may monitor control signals and/or signal strengths thereof to determine base stations, antenna arrays, and/or sectors suitable for communication. If wireless terminal 200 leaves the border area between sectors A′ and B″, wireless terminal 200 may transmit a notification of exit from the border area (e.g., a Radio Resource Control 1B message or RRC-1B message). Upon receipt of such an exit notification (through either base station 100′ or 100″) at block 423, processor 131 may terminate multipoint communications for wireless terminal at block 424, and revert to providing single point communications from only a primary antenna array of a primary base station at block 401 (e.g., antenna array 117a′ of base station 100′ if wireless terminal 200 moves into a central area of sector A′ or antenna array 117b″ of base station 100″ if wireless terminal 200 moves into a central area of sector B″). The exit notification (e.g., an RRC-1B message) may identify the base station, sector, and/or antenna array from which single point communications may be provided.

Looking again at blocks 405 and 407, if the load in sector B″ of base station 100″ is greater than the multipoint load threshold at block 407, processor 131 may block multipoint communications for mobile terminal 200 at block 408 (even though wireless terminal 200 is located in the border area between sectors A′ and B″), while continuing to provide single point communications for wireless terminal 200 by continuing to transmit all transport blocks of the data stream through network interface 135, base station controller 101, transceiver 109a′, and antenna array 117a′.

At block 409, processor 131 may initiate a multipoint timer responsive to blocking multipoint communications, and at block 415, processor 131 may monitor for expiration of the multipoint timer. At any time an exit notification (e.g., an RCC-1B message) is received from wireless terminal 200 (indicating exit of wireless terminal 200 from the border area between sectors A′ and B″) at block 411, processor 131 may revert to operations of blocks 401 and 402. Exit notifications are discussed in greater detail above with respect to block 423, and the exit notification may identify a sector and/or antenna array from which single point communications should be received at wireless terminal 200.

Responsive to expiration of the multipoint timer at block 415, processor 131 may compare a current load in sector B″ (the secondary sector) with the multipoint load threshold. Responsive to the load in sector B″ being less than the multipoint load threshold at block 437, processor 131 may transmit information (e.g., a Radio Resource Control Reconfiguration message or RRC-Reconfiguration message) at block 447 to set up multipoint communications with wireless terminal 200 in the border area between sector A′ and sector B″. Processor 131 may transmit the information (e.g., an RRC-Reconfiguration message) through transceiver interface 145, transceiver 109a′, and antenna array 117a′ to wireless terminal 200. Upon receipt of the information (e.g., RRC-ASU message), wireless terminal 200 may respond with a communication (e.g., a Radio Resource Control Active Set Update Complete message or RRC-ASU complete message) to confirm that the wireless terminal 200 is ready to receive multipoint communications. Responsive to receiving the RRC-ASU complete message from wireless terminal 200 at block 419, processor 131 may provide multipoint communications for wireless terminal 200 at block 421, and operations of blocks 421, 423, and 424 may be performed as discussed above.

Looking again at blocks 435 and 437, if the current load in sector B″ is greater than the multipoint load threshold at block 437, processor 131 may continue blocking multipoint communications for mobile terminal 200 at block 408 (even though wireless terminal 200 is located in the border area between sectors A′ and B″), while continuing to provide single point communications for wireless terminal 200 by transmitting all transport blocks of the data stream through network interface 135, base station controller 101′, transceiver 109a′, and antenna array 117a′. Moreover, processor 131 may re-initiate the multipoint evaluation timer at block 409 and wait for expiration of the multipoint evaluation timer at block 415 before rechecking a current load of sector B″ to determine whether multipoint communications may be provided for wireless terminal 200.

Operations of blocks 408, 409, 411, 415, 435, and 437 may thus be repeated while maintaining single point communications with wireless terminal 200 using antenna array 117a′ until either wireless terminal 200 exits the border area (as indicated by an RRC-1B message at block 411) or the load in sector B″ is less than the multipoint load threshold at block 437. As long as wireless terminal 200 remains in the border area between sectors A′ and B″, processor 131 may periodically check the load of sector B″ to determine whether multipoint communications are appropriate for wireless terminal 200. Moreover, the period of such checks may be determined by a duration of the multipoint evaluation timer.

When using either inter or intra node MP-HSDPA multipoint communications as discussed above with respect to FIGS. 3A and 3B, the primary antenna array (e.g., antenna array 117a or 117a′) may transmit transport blocks for first data and control channels (e.g., a first high speed shared control channel or HS-SCCH and a first high speed physical downlink shared channel or HS-PDSCH) to wireless terminal 200, and the secondary antenna array (e.g., antenna array 117b or 117b″) may transmit transport blocks for second data and control channels (e.g., a second high speed shared control channel or HS-SCCH and a second high speed physical downlink shared channel or HS-PDSCH) to wireless terminal 200. In the opposite direction, wireless terminal 200 may transmit a high speed dedicated physical control channel (HS-DPCCH) that is received by both primary and secondary antenna arrays.

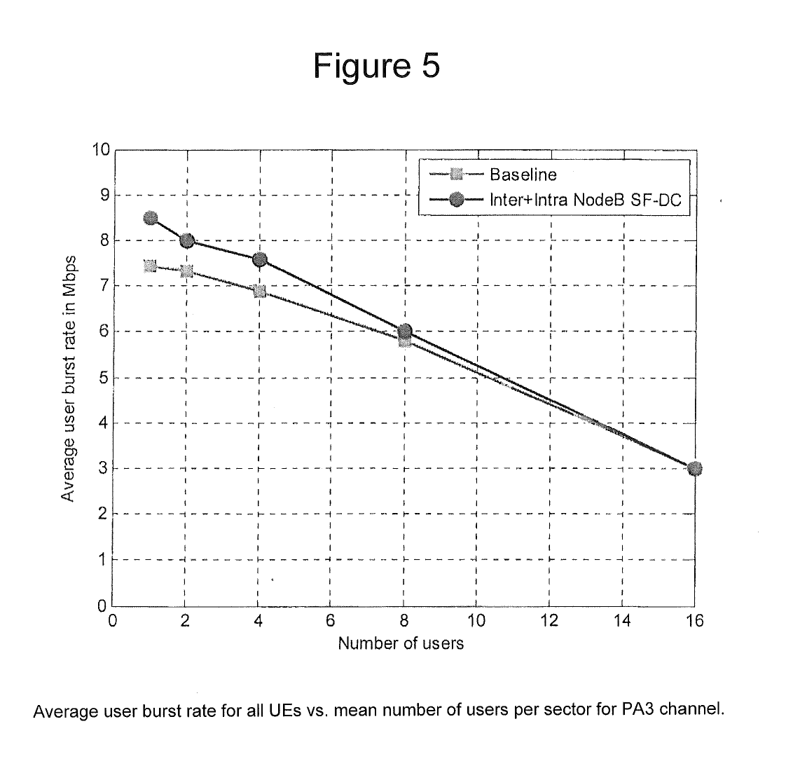

FIG. 5 is a graph illustrating simulated average user burst rates (i.e., burst rates for all wireless terminals in a sector) as a function of a number of users per base station sector for a PA3 channel. The lower line (with data points indicated by squares) represents a baseline of burst rate without using multipoint communications (also referred to as single-frequency-dual-cell or SF-DC communications). The upper line (with data points indicated by circles) represents burst rates when using multipoint communications (also referred to as SF-DC communications). As shown, with a lower number of users (wireless terminals) in the sector (e.g., a lower load), gains of up to 15% may be provided using MP-HSDPA multipoint communications. As a number of users in the sector increases (e.g., as load increases), however, these relative gains may diminish.

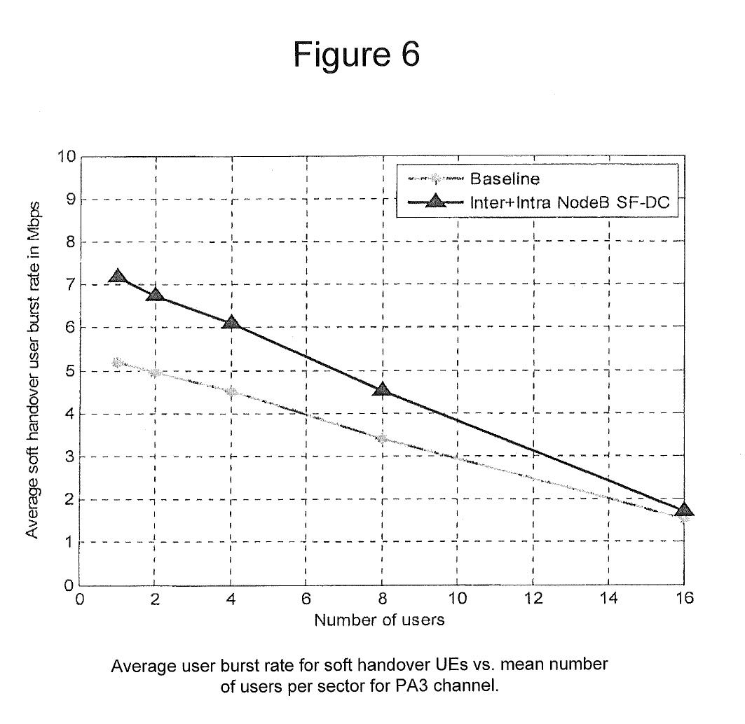

FIG. 6 is a graph illustrating simulated average soft handover user burst rates (i.e., burst rates for wireless terminals in a border area) as a function of a number of users per base station sector for a PA3 channel. The lower line (with data points indicated by circles) represents a baseline of burst rates without using multipoint communications (also referred to as SF-DC communications). The upper line (with data points indicated by triangles) represents burst rates using multipoint communications (also referred to as SF-DC communications). As shown, with a lower number of users in the sector (e.g., a lower load), gains of up to 40% may be provided for border area wireless terminals using MP-HSDPA multipoint communications. As a number of users in the sector increases (e.g., as load increases), however, these relative gains may diminish.

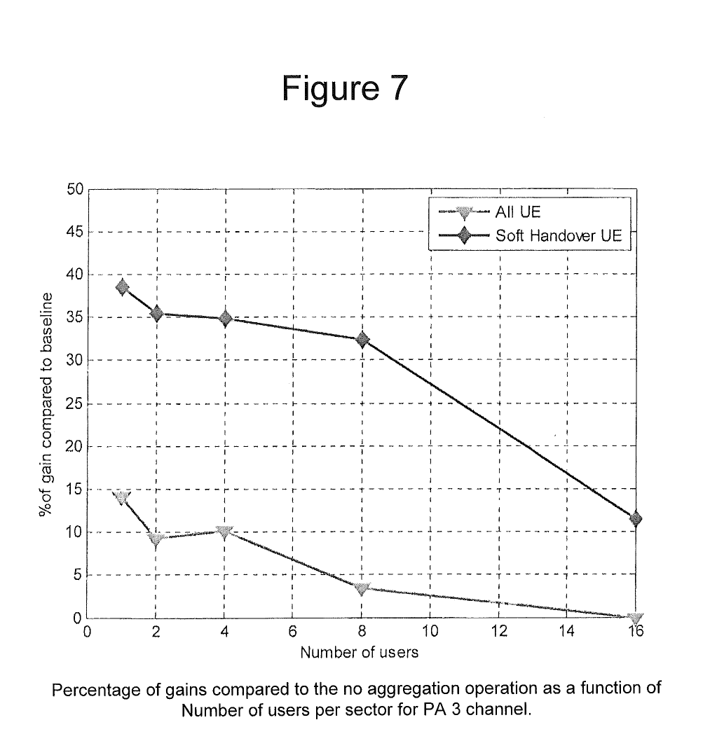

FIG. 7 is a graph illustrating simulated percentages of gain using MP-HSDPA multipoint communications compared to operations without MP-HSDPA multipoint communications. The lower line (with data points indicated by triangles) represents percentage gains for all wireless terminals in the sector when HP-HSDPA multipoint communications are used (compared to operations without multipoint communications), and the lower line thus summarizes the data of FIG. 5. The upper line (with data points indicated by diamonds) represents percentage gains for soft handover wireless terminals (i.e., wireless terminals in border areas between sectors) in the sector when HP-HSDPA multipoint communications are used (compared to operations without multipoint communications), and the upper line thus summarizes the data of FIG. 6.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the invention. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention. Accordingly, the above disclosed subject matter is to be considered illustrative, and not restrictive, and the appended claims are intended to cover all such modifications, enhancements, and other embodiments, which fall within the spirit and scope of the present invention. Thus, to the maximum extent allowed by law, the scope of the present invention is to be determined by the broadest permissible interpretation of the following claims and their equivalents, and shall not be restricted or limited by the foregoing detailed description. Any reference numbers in the claims are provided only to identify examples of elements and/or operations from embodiments of the figures/specification without limiting the claims to any particular elements, operations, and/or embodiments of any such reference numbers.

What is claimed is:

1. A method providing communications for a wireless terminal in a wireless communication network, the method comprising:
providing communications for the wireless terminal from a first antenna array for a first base station sector;
responsive to receiving an entry notification that the wireless terminal has entered a border area between the first base station sector and a second base station sector, comparing a load in the second base station sector with a load threshold; and
responsive to the load in the second base station sector being less than the load threshold, providing multipoint communications for the wireless terminal through the first antenna array for the first base station sector and through a second antenna array for the second base station sector.

2. The method of claim 1 further comprising:
responsive to the load in the second base station sector being greater than the load threshold, blocking multipoint communications for the wireless terminal while continuing to provide communications for the wireless terminal through the first antenna array of the first base station sector.

3. The method of claim 2 wherein comparing the load comprises comparing a first load with the load threshold at a first time, the method further comprising:
responsive to blocking multipoint communications for the wireless terminal, initiating a multipoint evaluation timer;
responsive to expiration of the multipoint evaluation timer, comparing a second load in the second base station sector with the load threshold at a second time subsequent to the first time; and
responsive to the second load in the second base station sector being greater than the load threshold, blocking multipoint communications for the wireless terminal while continuing to provide communications for the wireless terminal through the first antenna array for the first base station sector.

4. The method of claim 1 further comprising:
responsive to receiving an exit notification that the wireless terminal has exited the border area between the first base station sector and the second base station sector after providing multipoint communications, terminating multipoint communications for the wireless terminal.

5. The method of claim 4 further comprising:
after terminating multipoint communications, maintaining communications with the wireless terminal through one of the first antenna array for the first base station sector or the second antenna array for the second base station sector.

6. The method of claim 1 wherein the first antenna array for the first base station sector and the second antenna array for the second base station sector comprise respective directional first and second antenna arrays co-located at a same base station wherein the directional first and second antenna arrays are directed to different directions from the base station.

7. The method of claim 1 wherein the first antenna array for the first base station sector and the second antenna array for the second base station sector are located at respective separate and spaced apart first and second base stations.

8. The method of claim 1 wherein providing multipoint communications comprises transmitting a first transport block from the first antenna array for the first base station sector to the wireless terminal and transmitting a second transport block from the second antenna array for the second base station sector to the wireless terminal, wherein the first and second transport blocks are transmitted using a same frequency during a same time interval.

9. The method of claim 1 wherein the load in the second base station sector is determined based on usage by wireless terminals communicating through the second antenna array for the second base station sector.

10. The method of claim 9 wherein the load in the second base station sector is calculated based on the usage by the wireless terminals communicating through the second antenna array over a period of time that precedes receiving the notification that the wireless terminal has entered the border area.

11. A node in a wireless communication network providing communications for a wireless terminal wherein the wireless communication network includes first and second antenna arrays for respective first and second base station sectors, the node comprising:
an interface configured to provide a coupling with the first and second antenna arrays; and
a processor coupled to the interface wherein the processor is configured to provide communications for the wireless terminal through the interface and the first antenna array for the first base station sector, to compare a load in the second base station sector with a load threshold responsive to receiving an entry notification that the wireless terminal has entered a border area between the first base station sector and the second base station sector, and to provide multipoint communications for the wireless terminal through the interface and the first and second antenna arrays responsive to the load in the second base station sector being less than the load threshold.

12. The node of claim 11 wherein the processor is further configured to block multipoint communications for the wireless terminal while continuing to provide communications for the wireless terminal through the interface and the first antenna array responsive to the load in the second base station sector being greater than the load threshold.

13. The node of claim 12 wherein the processor is configured to compare the load by comparing a first load with the load threshold at a first time, to initiate a multipoint timer responsive to blocking multipoint communications for the wireless terminal, to compare a second load in the second base station sector with the load threshold at a second time subsequent to the first time responsive to expiration of the multipoint evaluation timer, and to block multipoint communications for the wireless terminal while continuing to provide communications for the wireless terminal through the interface and the first antenna array responsive to the second load in the second base station sector being greater than the load threshold.

14. The node of claim 11 wherein the processor is further configured to terminate multipoint communications for the wireless terminal responsive to receiving an exit notification that the wireless terminal has exited the border area between the first base station sector and the second base station sector.

15. The node of claim 14 wherein the processor is configured to maintain communications with the wireless terminal through the interface and one of the first antenna array or the second antenna array after terminating multipoint communications.

16. The node of claim 11 wherein the first antenna array and the second antenna array comprise respective directional first and second antenna arrays co-located at a same base station wherein the directional first and second antenna arrays are directed to different directions around the base station.

17. The node of claim 11 wherein the first antenna array and the second antenna array are located at respective separate and spaced apart first and second base stations.

18. The node of claim 11 wherein the processor is configured to provide multipoint communications by transmitting a first transport block through the interface and the first antenna array to the wireless terminal and by transmitting a second transport block through the interface and the second antenna array to the wireless terminal, wherein the first and second transport blocks are transmitted using a same frequency during a same time interval.

19. The node of claim 11 wherein the load in the second base station sector is determined based on usage by wireless terminals communicating through the second antenna array for the second base station sector.

20. The node of claim 19 wherein the load in the second base station sector is calculated based on the usage by the wireless terminals communication through the second antenna array over a period of time that precedes receiving the notification that the wireless terminal has entered the border area.
